(19) United States
(12) Patent Application Publication
(10) Pub. No.: US 2012/0133169 A1
(43) Pub. Date: May 31, 2012

(54) GLASS INTERIOR TRIM MEMBER

(75) Inventors: Todd George, Chelsea, MI (US); Alexander Klatt, Irvine, CA (US); Fairuz Jane Schlecht, Newport Beach, CA (US); Augusto Landestoy, Mission Viejo, CA (US); Dennis Reger, Commerce, MI (US); Ken Mertz, Ann Arbor, MI (US)

(73) Assignee: Fisker Automotive, Inc.

(21) Appl. No.: 13/144,077

(22) PCT Filed: Jan. 12, 2010
(86) PCT No.: PCT/US10/20753

§ 371 Date: Feb. 10, 2012

Related U.S. Application Data
(60) Provisional application No. 61/143,970, filed on Jan. 12, 2009.

(51) Int. Cl. B60R 13/02; E06B 3/24

(52) U.S. Cl. 296/1.08; 156/109

(57) ABSTRACT

A self-retaining trim member secured to an interior panel of the vehicle. The self-retaining trim member is a glass laminate member having a glass layer, a resin layer and a glass layer. The trim member also includes a tether having one end disposed in the resin layer and another end secured to the body of the vehicle. The trim member may include an embedded switch that senses touch and transfers a signal to a controller in order to control a desired operation.

### CROSS REFERENCE TO RELATED APPLICATIONS

This application claims the benefit of and priority to U.S. Provisional Application No. 61/143,970, filed Jan. 12, 2009, which is incorporated herein by reference.

### BACKGROUND

The present disclosure relates generally to a vehicle, and more particularly to a glass interior trim member.

### DESCRIPTION OF THE RELATED ART

Vehicles interiors generally include various features that may be decorative or functional in nature. An example of a feature that has such a dual purposes is a trim panel that enhances the aesthetic appearance of the interior and incorporates functional features such as an arm rest, storage compartment, switches, or the like. The trim panel may serve a safety function, under certain circumstances. For example, the trim component, such as a panel or bezel or the like may be retained or moves minimally when a force is exerted on the vehicle. In addition, the trim panel may be fabricated from various types of materials, such as fabric, metal, glass, plastic, or a combination thereof.

While various techniques are available to retain a trim component, they may not work as well with certain trim panel configurations or compositions. In addition, it may be desirable to embed another feature in the trim panel member, such as a switch. Thus, there is a need in the art for an improved method of limiting movement of a trim component due to an applied force to the exterior of the vehicle and for constructing the trim component.

### SUMMARY

Accordingly, the present disclosure relates to a self-retaining trim member secured to an interior panel of the vehicle. The self-retaining trim member is a glass laminate member having a glass layer, a resin layer and a glass layer. The trim member also includes a tether having one end disposed in the resin layer and another end secured to the body of the vehicle. The trim member may include an embedded switch that senses touch and transfers a signal to a controller in order to control a desired operation.

The present disclosure also provides a method constructing a glass laminate trim member for a vehicle. The method includes the step of providing a first layer member made of glass, a second layer member made of resin, and a third layer member made of glass. -Another step of the method includes embedding an object within the second layer member. The method further includes a step of positioning the second layer member between the first layer member and the third layer member. The method further includes a step of compressing the first layer member, the second layer member, and the third layer member together and a step of heating the second layer member such that the layers and object are secured together.

An advantage of the present disclosure is that an improved vehicle interior includes a trim member having an integral retention feature. Another advantage of the present disclosure is that the trim member is made from a glass laminate material. A further advantage of the present disclosure is that the trim member includes an embedded switch in the laminate layers. Still a further advantage of the present disclosure is that having a switch integrated into the glass eliminates the need for conventional interior mechanical switches.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle, according to an exemplary embodiment.

FIG. 2 is a perspective view of a vehicle interior illustrating the passenger compartment, according to an exemplary embodiment.

FIG. 3 is a perspective view of a vehicle door having a self-retaining trim member, according to an exemplary embodiment.

FIG. 4 is a perspective view of a vehicle door having a self-retaining trim member, according to an alternate embodiment.

FIG. 5 is an enlarged view of the vehicle door with self-retaining trim member, according to an exemplary embodiment.

FIG. 6 is an enlarged view of the self-retaining trim member having a tether, according to an exemplary embodiment.

FIG. 7 is a perspective view of the self-retaining trim member of FIG. 5 removed from the interior panel, according to an exemplary embodiment.

FIG. 8 is a diagram illustrating a method of forming the self-retaining trim member with an integral touch sensitive switch, according to an exemplary embodiment.

FIG. 9 is a diagram illustrating another method of forming the self-retaining trim member with an integral touch sensitive switch, according to an exemplary embodiment.

### DESCRIPTION

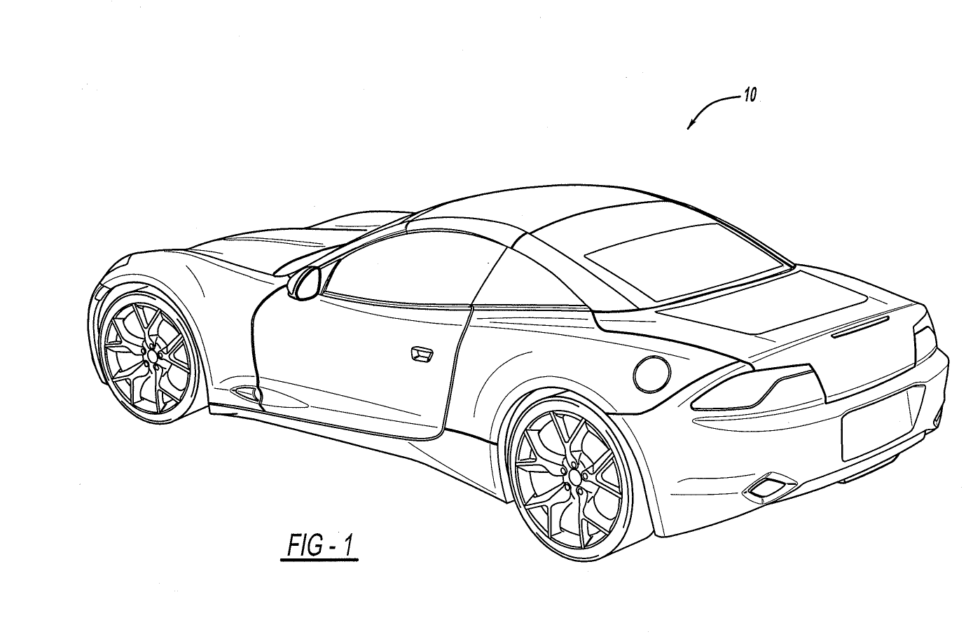

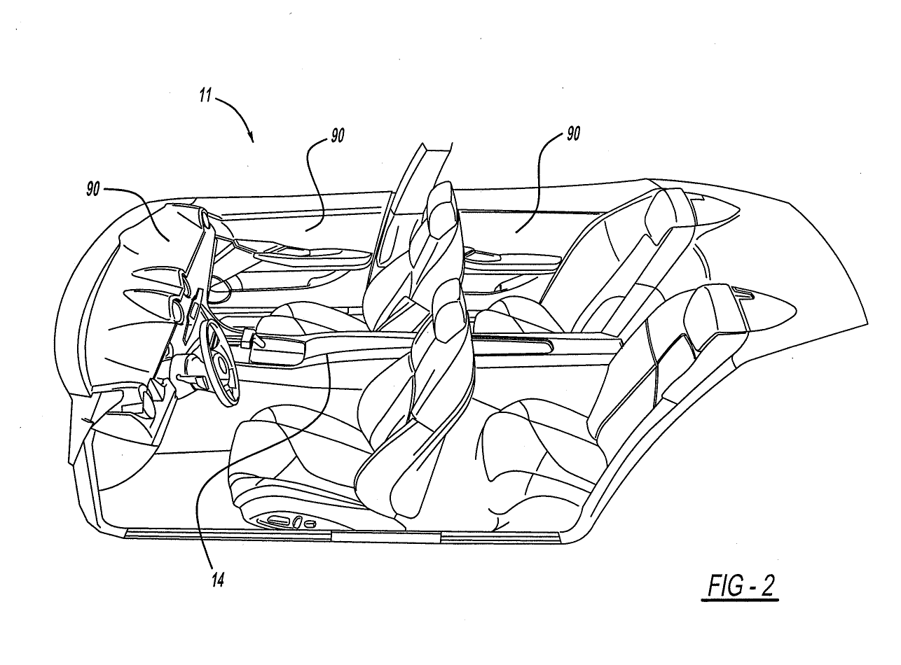

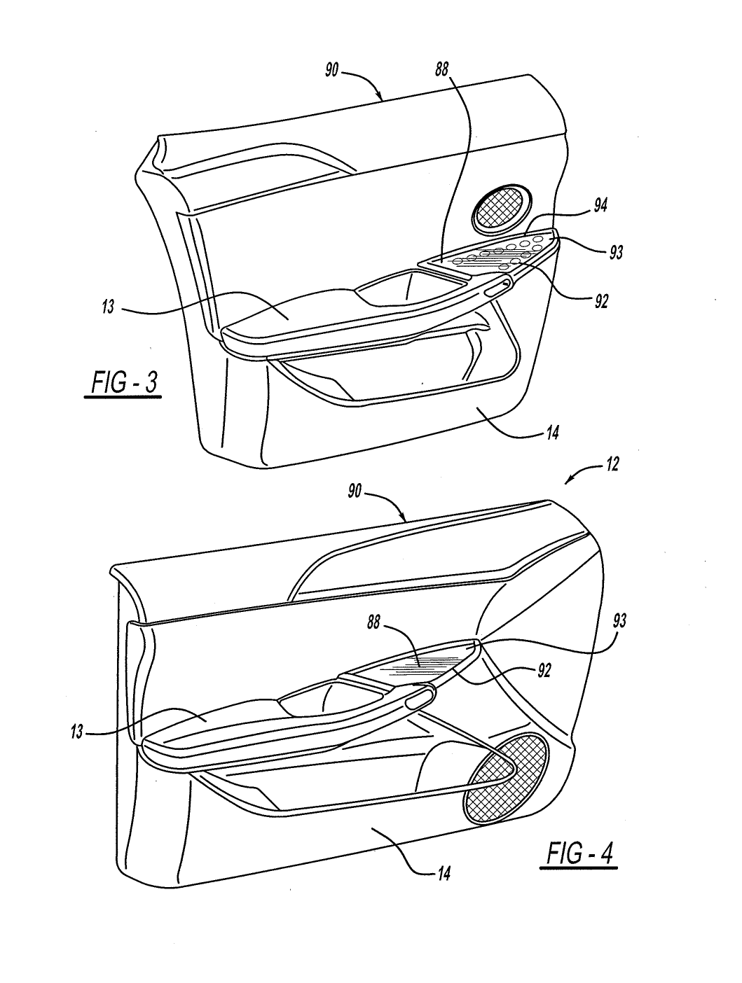

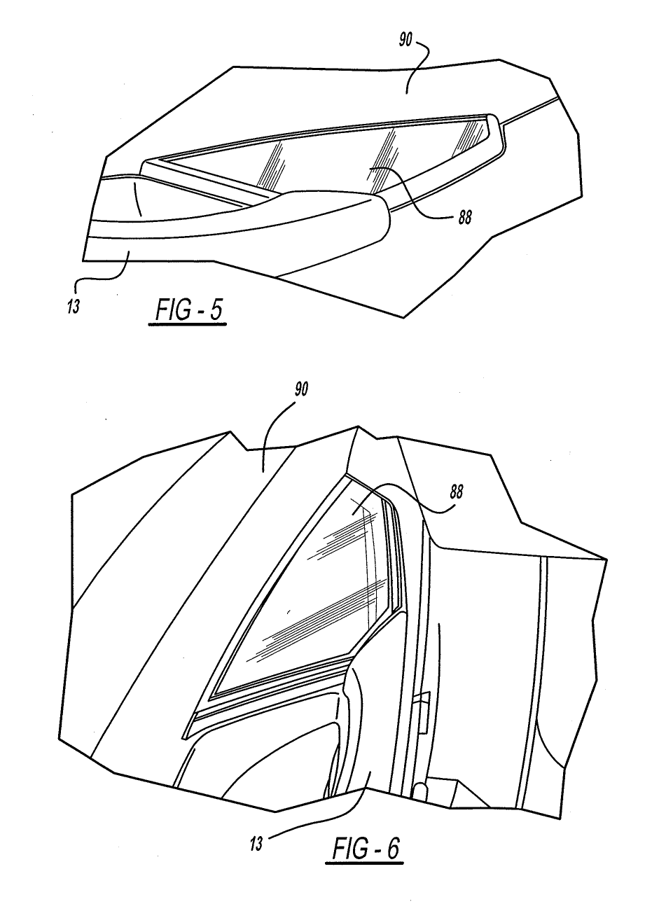

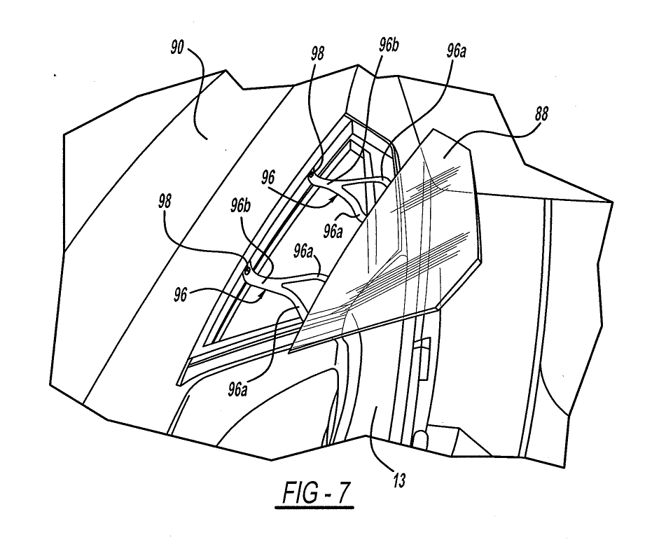

Referring generally to FIGS. 1-7, a vehicle 10 having a various compartments, including a passenger compartment 11 in the vehicle interior 12, is illustrated. The passenger compartment 11 includes various interior panels 90, such as an instrument panel, a door panel a side panel, a roof panel or the like. The interior panel 90 is generally planar, and may include an integrally formed feature. For example, the interior panel 90 may include an integrally formed door handle 13 or a storage compartment 14 or the like. In addition, the interior panel 90 may provide a support surface 15 for another component, such as gauges, instruments, screens, locking mechanisms, actuators or the like.

The interior panel 90 includes a self retaining trim member 88, which may be a separate member secured thereto or integrally formed thereof The trim member 88 may cover an opening formed in the interior panel 90. The trim member 88 may be decorative in nature, and may assume various shapes. It is contemplated, however, that the trim member 88 can be fabricated from other suitable materials such as plastic, metal, composite material, or the like.

In this example, the trim member 88 is generally planar, and formed using a glass laminate material 93. The glass laminate 93 may be opaque or translucent. For example, the glass laminate material 93 includes a first glass layer 34, a second resin layer 36 and a third glass layer 38 that are pressed together and heated. An example of a resin layer 36 is an ecologically friendly resin, such as PET. The resin layer 36 may include objects imbedded therein, such as for a decorative purpose.

The trim member 88 may be illuminated, such as by using a light member 94 selectively positioned in the panel opening, to serve as a back light. Additionally, the trim member 88 may be edge-lit by L.E.D. application to provide enhanced detail of decorative formation (i.e., chamfer, polished, frosted, etched). In this example, the light member 94 is a plurality of L.E.D. lights 92 arranged in a predetermined manner. In another example the light member 94 is embedded within a layer of the laminate material 93.

The trim member 88 is initially secured to the panel 90 using a conventional connection technique, such as an adhesive, a fastener or the like. However, the trim member 88 may become displaced due to an application of a predetermined force to the vehicle 10. The trim member 88 may include a connector 96, such as a tether, for securing the trim member 88 to the vehicle 10 and limiting movement of the trim member 88, such as movement that may occur due to the application of such a predetermined force to the vehicle 10. The tether 96 has a predetermined overall length, with a first end 96a secured to the trim member 88, and an opposed second end 96b secured to a portion of the vehicle 10, such as the frame. The first end 96a of the tether 96 may be integrally formed with the trim member 88, i.e. the tether 96 is an extension of the middle layer of the resin material 36. The second end of the tether 96 may be secured, such as by using a connector 98 such as a fastener, or an adhesive or the like. The tether 96 may be formed from a suitable material, such as a Mylar material or a nylon material or the like.

In operation, the trim member 88 is displaced from the panel 90 upon the application of a predetermined force to the vehicle 10. However, the overall length of the tether 96 limits or restricts movement of the trim member 88 within the interior 12 of the vehicle 10.

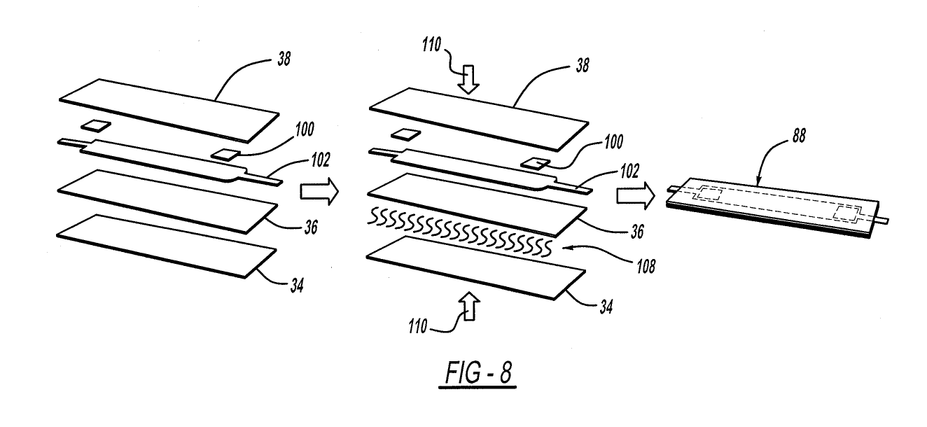

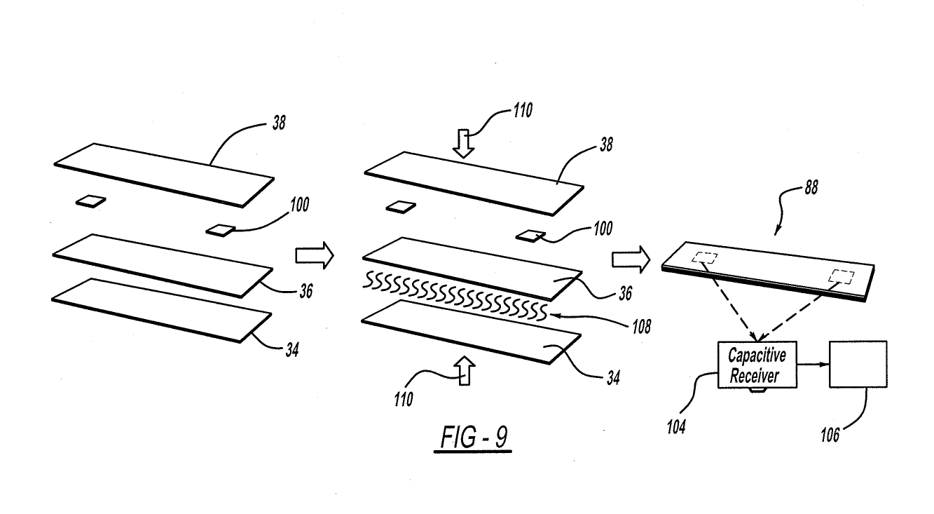

Referring to FIGS. 8 and 9, the trim member 88 may have a switch 100 integrally formed within the trim member 88. In an example shown in FIG. 8, the trim member 88 includes a first glass layer 34, and a second resin layer 36 as previously described. In this embodiment, the switch function is integrated into the glass by the application of touching the glass at a targeted location (e.g., capacitive touch sense switch, etc.). The trim member 88 further includes a conductive material 102 embedded in the second layer 36. An example of a conductive material 102 is a copper material, such as a copper wire. A switch 100, such as a capacitive sensor is positioned adjacent the conductive material 102, and is likewise embedded in the resin layer 36. The placement of each sensor 100 overlaps the conductive material 102 with the conductive material 102 extending to the edge of the glass at least at one location. This enables a hardwire connection to the conductive material 102 at the edge of the glass. The capacitive sensor 100 of this example is touch sensitive. The capacitive sensor 100 transmits a signal to a controller 106 to perform an operation (e.g., light on/off, door open/close, etc.). In this example, the signal is transferred using a wire to a vehicle controller 106. Referring now to FIG. 9, only the switch 100 is embedded in the resin layer 36. The switch 100 of this example is a touch sensitive transmitter that may be activated by, for example, a finger-touch to transmit a signal. The signal is transferred wirelessly to a receiver 104, such as a capacitive receiver, which in turn transmits the signal to the vehicle controller 106 to perform an operation (e.g., light on/off, door open/close, etc.).

Generally, the process of manufacturing the laminated glass trim member 88 includes a number of steps performed in a predetermined combination and/or sequence. First, the layers (e.g., first layer 34, second layer 36, etc.) and components or objects (e.g., conductive material 102, switch 100 (capacitive touch sense switch), tether 96, etc.) to be included in the glass laminated trim member 88 are selected. Next, the layers are positioned relative to one another (e.g., on top of one another, etc.) and the components (e.g., conductive layer and/or switches 100 are embedded within the second layer 36, etc.) are embedded in a predetermined layer (e.g., second layer (eco-resin) 36, etc.). The layers and components are then compressed (e.g., applying pressure, etc.) or squeezed such that the layers and components are adjacent one another. Next, a heat source is applied to the second layer (eco-resin) 36 to heat the second layer 36 and secure (fix) the layers and the components or objects (e.g., conductive layer 102, switches 100, tether 96, etc.) together. Next, other components (e.g., lighting, tethers 96, etc.) are attached to the trim member 88. It is noted that the steps outlined above are merely illustrative and that it is contemplated that the combination and sequence of these steps can be performed in other predetermined manners.

Many modifications and variations of the present disclosure are possible in light of the above teachings. Therefore, within the scope of the appended claim, the present disclosure may be practiced other than as specifically described.

1-20. (canceled)

21. An interior panel within a passenger compartment of a vehicle, comprising:
a trim member disposed on the interior panel, wherein the trim member is formed
from a laminate material having at least a first layer and a second layer;
a tether having a first end integrally formed between the first layer and second layer of the trim member and a second end secured to the vehicle, wherein the tether constrains movement of the trim member due to application of a force to the vehicle; and
a switch arranged on the trim member for providing a signal to a controller to perform a predetermined operation.

22. The interior vehicle panel of claim 21, wherein the trim member is a glass laminate member having a glass layer, a resin layer, and a glass layer, and the first end of the tether is embedded in the resin layer.

23. The interior vehicle panel of claim 22, wherein the resin layer includes an object embedded therein.

24. The interior vehicle panel of claim 22, wherein the switch is disposed between the first and second glass layers.

25. The interior vehicle panel of claim 22, wherein the switch is embedded in the resin layer.

26. The interior vehicle panel of claim 25, wherein the switch is in wireless communication with a receiver that is in operative communication with the controller.

27. The interior vehicle panel of claim 22, further comprising a conductive material embedded in the resin layer.

28. The interior vehicle panel of claim 27, wherein the conductive layer extends to an edge of the trim member such that a hardwire connection to the controller can be made thereto.

29. The interior vehicle panel of claim 21, wherein the switch includes a light emitting diode.

30. An interior panel within a passenger compartment of a vehicle, comprising:
a trim member disposed on the interior panel, wherein the trim member is formed from a glass laminate material having a first glass layer, a resin layer, and a second glass layer;
a tether having a first end in the resin layer of the trim member and a second end secured to the vehicle, wherein the tether constrains movement of the trim member due to application of a force to the vehicle; and
a switch arranged on the trim member for providing a signal to a controller to perform a predetermined operation.

31. The interior vehicle panel of claim 30, wherein the resin layer includes an object embedded therein.

32. The interior vehicle panel of claim 30, wherein the switch is disposed between the first and second glass layers.

33. The interior vehicle panel of claim 30, wherein the switch is in wireless communication with a receiver that is in operative communication with the controller.

34. The interior vehicle panel of claim 30, further comprising a conductive material embedded in the resin layer.

35. The interior vehicle panel of claim 30, wherein the conductive layer extends to an edge of the trim member such that a hardwire connection to a controller can be made thereto.

36. The interior vehicle panel of claim 31, wherein the object is a light emitting diode.

37. A method of constructing a glass laminate trim member for a vehicle, the method comprising:
providing a first layer member made of glass, a second layer member made of resin, and a third layer member made of glass;
embedding a switch within the second layer member;
positioning the second layer member between the first layer member and the third layer member;
compressing the first layer member, the second layer member, and the third layer member together; and
heating the second layer member such that the first layer, the second layer, the third layer, and the switch are secured together.

38. The method of claim 37, wherein embedding comprises embedding a first end of a tether in the second layer, a second end of the tether attachable to the vehicle.

39. The method of claim 37, wherein embedding comprises embedding one of a sensor and a conductive member in the second layer.

40. The interior vehicle panel of claim 21, wherein the switch is configured to sense touch and transfer a corresponding signal to the controller based on the sensed touch.
